(19) United States
(12) Patent Application Publication
(10) Pub. No.: US 2026/0142966 A1
(43) Pub. Date: May 21, 2026

(54) DEVICE BOOTSTRAP USING PASSWORD AUTHENTICATION KEY EXCHANGE AND ATTESTATION

(71) Applicant: Cisco Technology, Inc., San Jose, CA (US)

(72) Inventors: Owen Friel, Salthill (IE); Eliot Lear, Wetzikon (CH)

(21) Appl. No.: 18/950,719

(22) Filed: Nov. 18, 2024

(51) Int. Cl. H04L 9/40

(52) U.S. Cl. CPC H04L 63/083; H04L 63/0823

(57) ABSTRACT

Techniques for cryptographically binding password authentication key exchange (PAKE) information with a manufacturing installed certificate (MIC) during device bootstrapping. An authentication server of a network receives an indication that a client device is attempting to join a network, the indication includes first PAKE information. The authentication server receives a MIC from a client device, wherein the MIC includes a hash of second PAKE information, the second PAKE information associated with the client device and embedded in a n extension of the MIC. The authentication server determines whether the first PAKE information corresponds to the second PAKE information, and if it does the authentication server allows the client device to join the network.

### TECHNICAL FIELD

The present disclosure relates generally to cryptographically binding password authentication key exchange (PAKE) information with a manufacturing installed certificate (MIC) for zero touch device bootstrapping with mutual authentication between a client device and a network.

### BACKGROUND

In today's networking environment, being able to ensure that a new or factory reset device attempting to onboard or bootstrap and join an enterprise network is secure, authentic, and uncompromised is a must. Whether a network is wired or wireless, it is of utmost importance to ensure that both the network and the device can trust each other, that they are who they say they are, and that neither have been compromised in any way. The device needs a guarantee that the device is connecting to a correct or owner's network and the network needs a guarantee that the device is a trusted device that has been explicitly authorized, and is from a trusted manufacturer. This need for devices and networks to trust each other hold true whether the devices are IoT device in a smart home network, or end user client devices in an enterprise network.

One conventional approach to ensuring the security and authenticity of IoT devices in IoT networks (e.g., in a smart home) is connectivity standards alliance (CSA) Matter. Matter is a smart home protocol that ensures devices provide identification documentation in the form of an attestation keypair and an x.509 certification issued by a trusted certificate authority (CA) when connecting to a network. Typically, a new Matter device will have a QR code attached, or a numeric input code attached to the device. To onboard, a user simply scans the QR code or manually enters the numeric input code using the devices maker's application or a smart home platform application. This allows the device and a network authentication server or entity to use a password authentication key exchange (PAKE) to onboard the device into the network.

Another conventional approach to ensuring the security and authenticity of devices attempting to onboard in a Wi-Fi network is using Device Provisioning Protocol (DPP). DPP is a protocol that can securely onboard IoT devices onto a Wi-Fi network by eliminating the need for manual entry of Wi-Fi passwords. DPP enables the ability to provision devices with network credentials without the exchange of these credential over the air, which can minimize the risk of interception by a malicious entity. Similar to CSA Matter, DPP can be initiated by scanning a QR code, tapping an NFC tag, or through a cloud-based approach.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment that may implement various aspects of the technologies directed to cryptographically binding password authentication key exchange (PAKE) information with a manufacturing installed certificate (MIC) for zero touch device bootstrapping with mutual authentication between a client device and the network.

FIG. 2 illustrates a TLS flow diagram example for cryptographically binding PAKE information with a device MIC.

FIG. 3 illustrates an example flow diagram associated with the techniques described herein for Wi-Fi discovery for devices having PAKE information and a MIC that are cryptographically bound.

FIG. 4 illustrates a flow diagram of an example method for cryptographically binding password authentication key exchange (PAKE) information with a manufacturing installed certificate (MIC) for zero touch device bootstrapping with mutual authentication between a client device and the network.

FIG. 5 illustrates a flow diagram of an example method for a client device joining a network based on cryptographically binding password authentication key exchange (PAKE) information with a manufacturing installed certificate (MIC).

FIG. 6 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes a method that includes determining, receiving, by an authentication server of a network, an indication that a client device is attempting to join the network, the indication including first password authentication key exchange (PAKE) information. The method may also include receiving, by the authentication server of the network, a manufacturing installed certificate (MIC) from a client device, wherein the MIC includes a hash of second PAKE information, the second PAKE information associated with the client device and embedded in an extension of the MIC. The method may also include determining, by the authentication server of the network, whether the first PAKE information corresponds to the second PAKE information Finally, the method may include allowing, by the authentication server of the network and based at least in part on the first PAKE information corresponding to the second PAKE information, the client device to join the network.

Additionally, the techniques described herein may be performed by a system and/or device having non-transitory computer-readable media storing computer-executable instructions that, when executed by one or more processors, performs the method described above.

### Example Embodiments

Being able to ensure devices and networks can trust each other when a new or factory reset device is attempting to onboard in a network is crucial for ongoing network security. Whether a network is wired or wireless, it is of utmost importance to verify that both the network and the device can trust each other, that they are who they say they are, and that neither have been compromised in any way. Devices need to know that they are connecting to a correct or owner's network and the network needs to guarantee that the device is a trusted device, from a trusted manufacturer, and has explicit authorization to join the network.

Manufacturing installed certificates (MICs) are used by manufacturers to assert that a device meets certain requirements. MICs are signed by a trusted manufacturer root certificate authority (CA) and are installed at manufacturing time. A MIC is an attestation certificate, authenticating the device can be trusted. A MIC is sent by a device in a transport layer security (TLS) certificate message to an authentication, authorization, and accounting (AAA) server (e.g., RADIUS). The MIC private key is used to generate the CertificateVerify message to prove ownership of the private key. The AAA server checks the certificate signing chain on the MIC and ensures that the device has a MIC that is issued by a trusted manufacturers root CA. However, MICs cannot be used on their own to bootstrap a device onto a network, because devices will not have a built-in trust anchor to trust the network. Additionally, burned in password authentication key exchanges (PAKEs) can be seeded in both devices and network to establish trust. PAKEs allow for two or more parties to establish cryptographic keys based on one or more party's knowledge of a password.

However, attestation certificates, or MICs, are not linked to a PAKE. Thus, a PAKE can be stolen from a broken device or discovered through exhaustive search, or simply scanned from a QR that may be on the device, a label, or the device box. The stolen PAKE can then be applied to a class of hacked devices that have no business on the network, but have valid attestation certificates. Therefore, there is a need to link, or cryptographically bind, a PAKE to a MIC.

This disclosure is directed to techniques for cryptographically binding a PAKE to a device MIC. This binding ensures that a device is guaranteed to connect to the correct or owner's network, and the network is guaranteed that the device is a trusted device that has been explicitly authorized and is from a trusted manufacturer. By binding the PAKE to the device MIC there is a guarantee that if a device has a compromised attestation certificate, it cannot be used to impersonate another device that has been provisioned on the network by not yet bootstrapped.

To implement techniques for cryptographically binding a PAKE to a device MIC, a client device has baked into it at manufacturing time a low entropy password that will be used in a PAKE handshake, and an X.509 initial device identity (IDevID), or manufacturing installed certificate (MIC) that is signed by a trusted manufacturing root CA. To cryptographically bind the PAKE to the MIC, the MIC will include a hash of the PAKE information embedded in an extension.

Bootstrap authentication happens during an IEEE 802.1X extensible authentication protocol (EAP) transaction between a new or factory reset client device attempting to join a network (either Wi-Fi of wired) for a first time, and an authentication authorization and accounting (AAA) server (e.g., RADIUS server). Mutual authentication of the client device to the authentication server, and vice versa, is based on a shared PAKE password that is embedded in the device a provisioned into the authentication server. Device attestation is based on an X.509 manufacturer installed certificate (MIC) embedded in the client device that has an X.509 signature chain back to a manufacturer's root certificate authority (CA) that is trusted by the authentication server. The X.509 MIC contains an extension that equals a hash of the PAKE information, thus binding the client device PAKE to the client device MIC. The PAKE and the X.509 MIC are both verified in a TLS handshake by the authentication server. An X.509 locally significant certificate (LSC) is provisioned by the authentication server onto the client device once authentication and attestation are complete. If the network the client device is bootstrapping onto is a Wi-Fi network, the client device will send out a “chirp” message over Wi-Fi that includes a hash of its PAKE information. The network that owns the client device and knows the corresponding cleartext PAKE information will respond with a message over Wi-Fi instructing the device to connect and start an 802.1X bootstrap authentication exchange. Well behaved networks with no knowledge of the client device PAKE will not reply. Even if a network without the client device PAKE does reply, the network will not be able to complete the PAKE TLS handshake, and the client device will reject the rogue network and not connect.

Mutual authentication between a client device and a network is based on a PAKE. Any suitable PAKE algorithm may be used including but not limited to RFC9382 SPAKE2, a password-authenticated key exchange; RFC9383 SPAKE2+, an augmented password-authenticated key exchange protocol; the OPAQUE augmented PAKE protocol/the OPAQUE asymmetric PAKE protocol; RFC5054 using the secure remote password protocol for TLS authentication; and any other appropriate PAKE algorithm.

The PAKE shared password is baked into the device at manufacturing time. The PAKE will also have associated information including the choice of PAKE protocol, any parameters required by the protocol, and an identifier that the server can use to identify a specific device, among others. A hash of some or all of this PAKE information that is associated with the client device will be included at manufacturing time in an extension in the client device's attestation X.509 MIC. At a minimum, this hash will be over the device PAKE identifier and password. The hashing mechanism and algorithm could be defined, and the authentication server may execute the hashing mechanism itself, or the hash may be pre-calculated and included in the PAKE information.

Additionally, the PAKE information may be imported into the authentication server to enable the client device to bootstrap. The PAKE information may be delivered to the authentication server via multiple mechanisms. For example, the PAKE information may encoded in a QR code etched onto the client device, or a label attached to the client device, or on a label on a device box or other packaging. The QR code may be scanned by an application that can upload the PAKE information to the authentication server. Alternately or in addition, PAKE information for one or more devices may be included in a bill of materials (BOM) that is uploaded to the authentication server via an API or GUI. Note, these are examples of mechanisms for delivering the PAKE information to an authentication server and are not meant to be limiting, any appropriate mechanism may be used to deliver PAKE information for one or more client devices to the authentication server of a network. The PAKE information is used during an EAP TLS handshake to mutually authenticate the client device and the network authentication server. If either side detects that the TLS handshake fails, the connection is terminated, and onboarding fails.

Device attestation is achieved using an X.509 MIC installed at manufacturing time. This MIC is sent by a client device to a network authentication server in a TLS certificate message. The MIC private key is used to generate the CertificateVerify message to prove ownership of the private key. The authentication server checks the certificate signing chain on the MIC and ensures that the device has a MIC that is issued by a trusted manufacturers root CA. Additionally, the network authentication server checks that a hash of the PAKE information is included in an extension of the MIC and that the PAKE information matches the PAKE information that has been provisioned on the authentication server via a scanned QR code or other mechanism as described above. This check ensures that if a device is compromised and its MIC private key exposed, then the attacker cannot use that MIC to attempt to enroll against a PAKE that is associated with an uncompromised device that has been provisioned on the authentication server. A suitable TLS PAKE mechanism should be used that allows for use of both PAKE and client CertificateVerify or VertificateVerify messages simultaneously. Suitable mechanisms include, but are not limited to, usage of PAKE with TLS 1.3, or OPAQUE with TLS 1.3.

When the TLS handshake completes, both the client device and the network authentication server will have verified the PAKE, and the authentication server will have validated the device attestation MIC, the client device proceeds to perform certificate enrollment inside the EAP transaction using the mechanisms defined in tunnel extensible authentication protocol (TEAP).

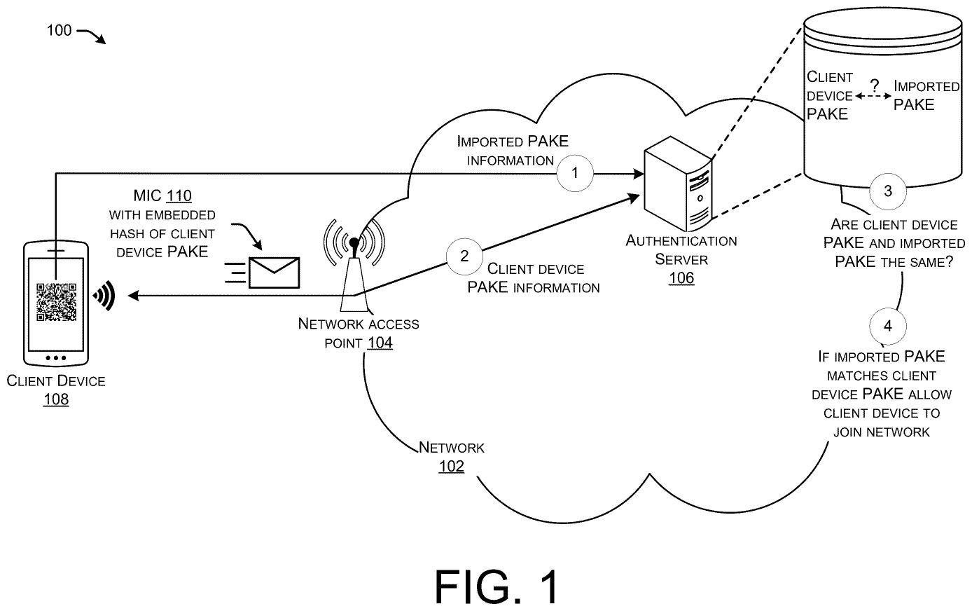

FIG. 1 illustrates an example environment 100 that may implement various aspects of the technologies directed to cryptographically binding password authentication key exchange (PAKE) information with a manufacturing installed certificate (MIC) for zero touch device bootstrapping with mutual authentication between a client device and a network. Environment 100 includes a network 102. Network 102 may be a wired network or a wireless network. Network 102 may be any appropriate type of network that includes multiple devices linked together for facilitating data communication, (e.g., LAN, WAN, etc.). Network 102 may be a network fabric that includes multiple different network devices such as network access point 104, switches, bridges, routers, firewalls, repeaters, gateways, hubs, and the like. Network 102 may be an enterprise network and IoT network, a wired network, a Wi-Fi network, or any other appropriate type of network. Network 102 is an example network, and any particular network may include more of less network devices of various kinds. Environment 100 also include authentication server 106. Authentication server 106 may be an authentication authorization and accounting (AAA) server such as RADIUS, or any other appropriate type of authentication server. Environment 100 includes client device 108. Client device 108 may be a new or factory reset device attempting to join network 102 for a first time. Client device 108 may be a user device (e.g., smart phone, laptop, desktop computer, etc.), or an IoT device (e.g., a smart home device such as a thermostat, camera, lighting device, appliance, etc.). Finally, environment 100 includes a MIC 110 of the client device 108. The MIC 110 may be an X.509 initial device identity (IDevID) or manufacturing installed certificate that is signed by a trusted manufacturer root CA. The MIC 110 in environment 100 includes a hash of the client device PAKE in an extension.

To implement techniques described herein for cryptographically binding password authentication key exchange (PAKE) information with a manufacturing installed certificate (MIC) for zero touch device bootstrapping with mutual authentication between a client device and a network, at (1) PAKE information associated with a client device 108 is imported by the authentication server 106. The PAKE information may include a PAKE password, identifier that the authentication server can use to identify a specific device, a choice of PAKE protocol, and PAKE parameters required by the protocol. The PAKE information may be imported via any appropriate mechanism. For example, the PAKE information may be imported by scanning a QR code that includes the information, and/or the PAKE information may be imported via a GUI or API. For example, if network 102 is an IoT network, such as a smart home network, and client device 108 is a new or factory reset smart home IoT device, a user may scan a QR code that is in some way attached or associated with the client device 108 (e.g., etched on the device, a tag affixed to the device, or packaging etc.) and via an application associated with the device manufacturer, the authentication server 106 may import the PAKE information. Scanning a QR code is used herein as an example for importing PAKE information to an authentication server and is not meant to be limiting, any appropriate means of importing PAKE information to the authentication server may be used.

At (2) the authentication server 106 receives a MIC 110 from the client device 108. The MIC 110 has a hash of the PAKE information associated with the client device 108 embedded in an extension of the MIC. Although environment 100 illustrates a wireless client device 108 communicating with the authentication server 106 of wireless network 102 via a network access point 104, the techniques described herein for cryptographically binding PAKE information with a MIC for zero touch device bootstrapping with mutual authentication between a client device and a network, may also b3e implemented with a wired network. MIC 110 may be sent from client device 108 to authentication server 106 in a CertificateVerify message during a TLS handshake. Additionally, if network 102 is a Wi-Fi network, client device 108 sends out a “chirp” message that includes the hash of the PAKE associated with client device 108. If authentication server 106 has the PAKE information associated with client device 108 (e.g., the PAKE information was imported in step (1 )), the authentication server will recognize the client device as belonging to network 102 and will reply to the chirp instructing client device 108 to initiate an 802.1X bootstrapping authentication flow against the authentication server 106.

At (3) when the authentication server 106 receives the MIC 110 the authentication server verifies that the MIC 110 is signed by a trusted manufacturer root CA. Additionally, the authentication server 106 compares the PAKE that is hashed and embedded in the MIC 110 extension to the PAKE that was imported by authentication server 106 in step (1). If the imported PAKE and the PAKE hashed and embedded in the MIC extension match, the authentication server 106 knows that the client device 108 is uncompromised. Thus, at (4) if the authentication server determines that the imported PAKE matches the client device PAKE embedded in MIC 110, the authentication server 106 allows the client device 108 to bootstrap onto the network 102.

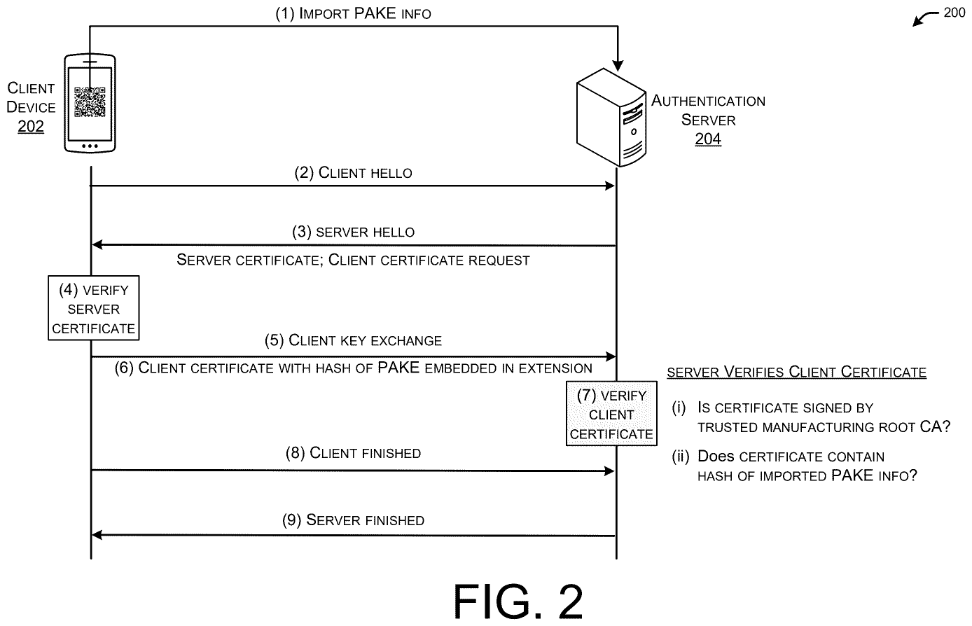

FIG. 2 illustrates a TLS communication flow example 200 for cryptographically binding PAKE information with a client device MIC. Example 200 includes communication between a client device 202 and an authentication server 204. Client device 202 may be the same or similar to client device 108 as described with reference to FIG. 1. For example, client device 202 may be a new or factory reset device attempting to join a network for a first time. Client device 108 may be a user device (e.g., smart phone, laptop, desktop computer, etc.), or an IoT device (e.g., a smart home device such as a thermostat, camera, lighting device, appliance, etc.). Similarly, authentication server 204 may be the same or similar to authentication server 106 as described with reference to FIG. 1. For example, authentication server 204 may be an authentication, authorization, and accounting (AAA) server such as RADIUS, or any other network authentication server.

Example 200 a typical example of communications between the client device 202 and the authentication server 204 for mutual authentication based on a shared PAKE password that is embedded in the client device 202 and provisioned the authentication server 204. The bootstrap authentication happens during an 802.1X EAP transaction between the client device 202 and the network authentication server 204, where a PAKE associated with the client device 202 and an X.509 MIC of the client device 202 are both verified in a TLS handshake by the authentication server 204.

At (1) PAKE information associated with a client device 202 is imported by the authentication server 204. The PAKE information may include a PAKE password, identifier that the authentication server can use to identify a specific device, a choice of PAKE protocol, and PAKE parameters required by the protocol. The PAKE information may be imported via any appropriate mechanism. For example, the PAKE information may be imported by scanning a QR code that includes the information, and/or the PAKE information may be imported via a GUI or API. For example, if a network is an IoT network, such as a smart home network, and client device 108 is a new or factory reset smart home IoT device, a user may scan a QR code that is in some way attached or associated with the client device 202 (e.g., etched on the device, a tag affixed to the device, or packaging etc.) and via an application associated with the device manufacturer, the authentication server 204 may import the PAKE information. Scanning a QR code is used herein as an example for importing PAKE information to an authentication server and is not meant to be limiting, any appropriate means of importing PAKE information to the authentication server may be implemented.

At (2) a standard TLS handshake is initialed, in which the client device 202 sends a client hello message to the authentication server 204. In response, at (3) the authentication server 204 sends a server hello message back to the client device 202. This message includes a server certificate and a request for the client device 202 to send a client certificate. At (4) when the client device 202 receives the server certificate, the client device verifies the server certificate and at (5) responds with a client key exchange. In addition, at (6) if the authentication server requests a client certificate, the client device 202 sends the authentication server 204 its client certificate. The client certificate may be an X.509 MIC with a hash of the PAKE information associated with the client device 202 embedded in an extension. At (7) when the authentication server 204 receives the client certificate, the authentication server 204 verifies the client certificate. To verify the client certificate, the authentication server 204 (i) checks and verifies that the certificate is signed by a trusted manufacturer root CA, and (ii) verifies that hash of the PAKE embedded in the MIC extension matches the imported PAKE that the authentication server received at (1). If the certificate is signed by and trusted manufacturer root CA and the hash of the PAKE embedded in the MIC extension matched the imported PAKE, the authentication server allows the client device 202 to bootstrap onto the network. At (8) the client device 202 transmits a client finished message and at (9) the server transmits a server finished message completing the TLS handshake. The client device 202 has now joined the network and communicate with other devices that are allow members of the network.

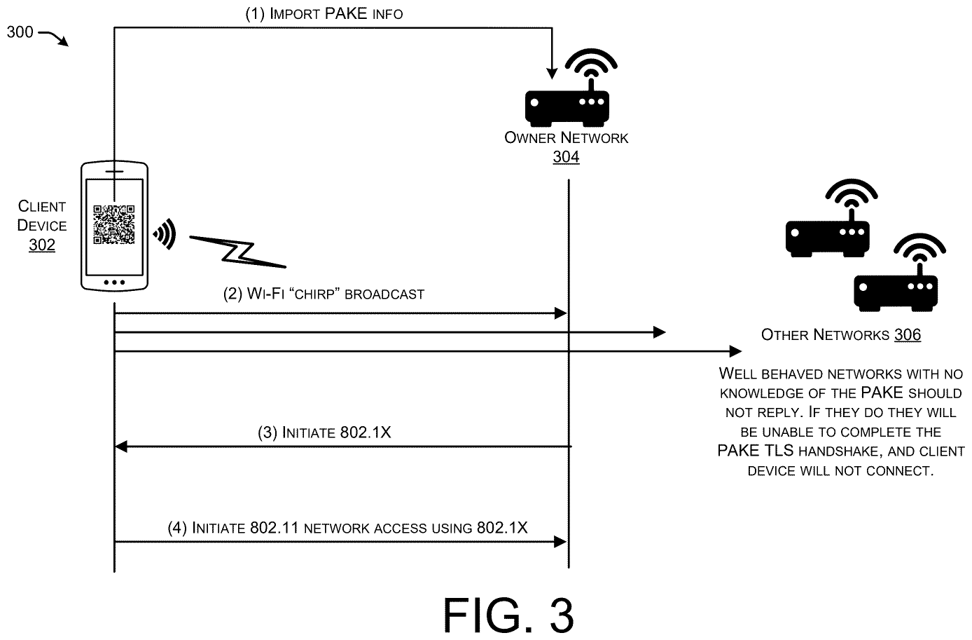

FIG. 3 illustrates an example flow diagram example 300 associated with the techniques described herein for Wi-Fi discovery for devices having PAKE information and a MIC that are cryptographically bound. Example 300 includes communication between a client device 302 and a network that the client device 302 belongs to, or owner network 304. Additionally, example 300 illustrates one or more other network 306 that the client device 302 is not a member of. Client device 302 may be a new or factory reset device attempting to join a network for a first time. Client device 302 may be a user device (e.g., smart phone, laptop, desktop computer, etc.), or an IoT device (e.g., a smart home device such as a thermostat, camera, lighting device, appliance, etc.). Owner network 304 is a wireless network. Network 304 may be any appropriate type of network that includes multiple devices linked together for facilitating data communication, (e.g., LAN, WAN, etc.). Network 304 may be a network fabric that includes multiple different network devices such as network access points, switches, bridges, routers, firewalls, repeaters, gateways, hubs, and the like. As an example, Network 304 may be a smart home network for IoT smart device. As such, when a user or homeowner has a new or factory reset smart device to that needs to be bootstrapped onto the owner network 304, at (1) PAKE information associated with the new client device 302 may be imported to an authentication server of owner network 304. Similar to step (1) as described with reference to FIG. 1 and FIG. 2, at step (1) PAKE information associated with the client device 302 is imported by the authentication server of owner network 304. The PAKE information may include a PAKE password, identifier that the authentication server can use to identify a specific device, a choice of PAKE protocol, and PAKE parameters required by the protocol. The PAKE information may be imported via any appropriate mechanism. For example, the PAKE information may be imported by scanning a QR code that includes the information, and/or the PAKE information may be imported via a GUI or API. For example, if owner network 304 is an IoT network, such as a smart home network, and client device 302 is a new or factory reset smart home IoT device, a user may scan a QR code that is in some way attached or associated with the client device 302 (e.g., etched on the device, a tag affixed to the device, or packaging etc.) and via an application associated with the device manufacturer, the authentication server of owner network 304 may import the PAKE information.

At (2) the client device 302 broadcasts a Wi-Fi chirp message. This message may be an 802.11 public action frame containing a hash of the PAKE information associated with the client device 302. Only the networks that have been provisioned with the client device 302 PAKE information will reply. The owner network 304 has been provisioned with the client device 302 PAKE information at (1) and will respond at (3) instructing the client device 302 to initiate an 802.1X bootstrapping authentication flow against the owner network's authentication server. Thus, at (4) the client device 302 initiates the 802.11 network access using 802.1X EAP transaction for PAKE authentication, device attestation, and LSC enrollment as describe with reference to FIG. 2 above.

The other networks 306 that have not been provisioned with the client device 302 PAKE information will not respond to the Wi-Fi chirp broadcast message send out by the client device 302 at (2) if they are well behaved. Even if they do respond to the Wi-Fi chirp broadcast message, the client device 302 will not be able to bootstrap onto the other networks 306 as they will be unable to complete the PAKE TLS handshake and the client device 302 will reject the other networks 306 and the client device 302 will not connect.

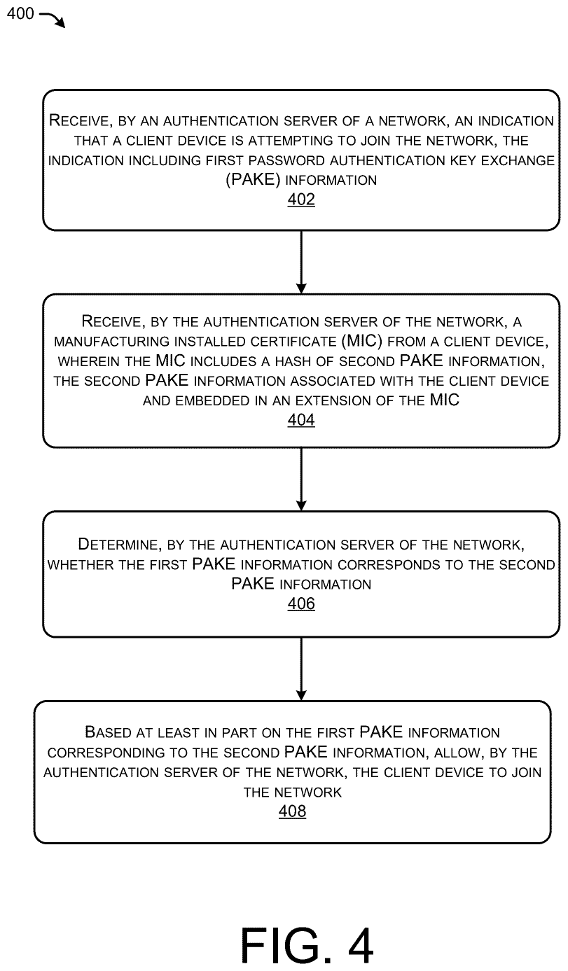

FIG. 4 is a flow diagram illustrating an example method 400 associated with the techniques described herein for configuring network devices to take an action, such as a snapshot capture of the devices state, in response to a trigger event such as an unexpected network event or network error. Example method 400 illustrates aspects of the functions performed by authentication server 106 as described with reference to FIG. 1, FIG. 2, and FIG. 3. The logical operations described herein with respect to FIG. 4 may be implemented (1) as a sequence of computer-implemented acts or program modules running on a computing system and/or (2) as interconnected machine logic circuits or circuit modules within the computing system. In some examples, the method(s) 400 may be performed by a system comprising one or more processors and one or more non-transitory computer-readable media storing computer-executable instructions that, when executed by the one or more processors, cause the one or more processors to perform the method(s) 400.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 402 an authentication server of a network receives an indication that a client device is attempting to join the network. The indication includes first password authentication key exchange (PAKE) information. For example, with reference to FIG. 1 at (1) PAKE information is imported by the authentication server 106. For instance, the PAKE information may be imported by scanning a QR code that includes the information, and/or the PAKE information may be imported via a GUI or API. For example, if network 102 is an IoT network, such as a smart home network, and client device 108 is a new or factory reset smart home IoT device, a user may scan a QR code that is in some way attached or associated with the client device 108 (e.g., etched on the device, a tag affixed to the device, or packaging etc.) and via an application associated with the device manufacturer, the authentication server 106 may import the PAKE information. Scanning a QR code is used herein as an example for importing PAKE information to an authentication server and is not meant to be limiting, any appropriate means of importing PAKE information to the authentication server may be implemented.

At operation 404 the authentication server of the network, receives a manufacturing installed certificate (MIC) from a client device. The MIC includes a hash of second PAKE information. The second PAKE information is associated with the client device and embedded in an extension of the MIC. For example, with reference to FIG. 1 the client device 108 sends its MIC 110 with a hash of its PAKE embedded in an extension of the MIC 110 to the authentication server 106. This message exchange occurs in a TLS handshake at described with reference to FIG. 2. For example, with reference to FIG. 2 at (6) the client device 202 sends a client certificate with a hash of its PAKE embedded in an extension of the certificate to the authentication server 204.

At operation 406 the authentication server of the network determines whether the first PAKE information corresponds to the second PAKE information. For example, with reference to FIG. 1 at (3) the authentication server 106 determines if the PAKE information imported at (1) matches the PAKE information embedded in the extension of the MIC 110 received at (2). In another example with reference to FIG. 2, at (7) the authentication server 204 verifies the client certificate by (i) verifying that the certificate is signed by a trusted manufacturer root CA and (ii) determining whether the PAKE hashed in the certificate matches the PAKE information imported at (1).

At operation 408 based at least in part on the first PAKE information corresponding to the second PAKE information, the authentication server of the network allows the client device to join the network. For example, with reference to FIG. 1 at (4) if the PAKE information imported at (1) matches the PAKE information hashed and embedded in the MIC 110 and received by the authentication server at (2), the client device 108 is bootstrapped onto the network 102.

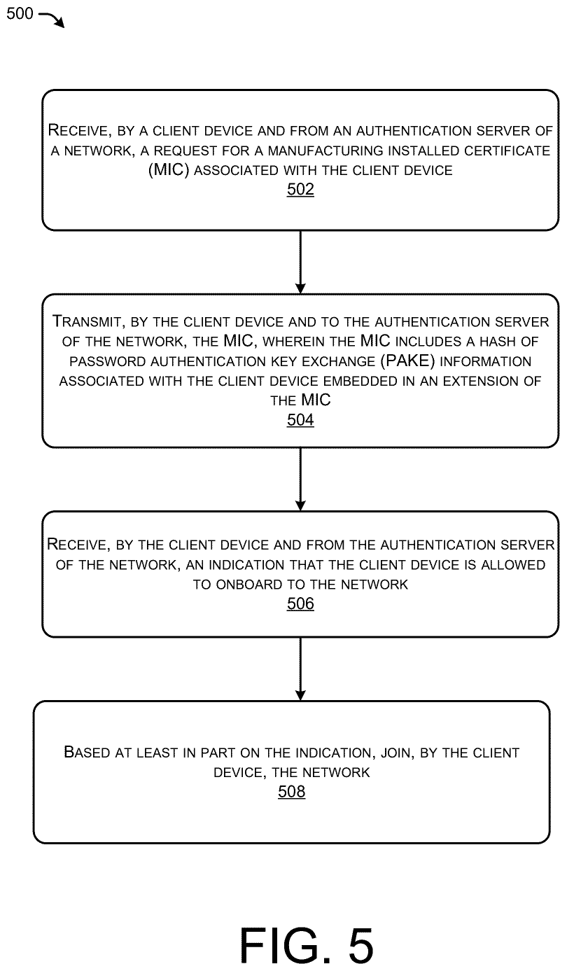

FIG. 5 is a flow diagram illustrating an example method 500 associated with the techniques described herein for a client device joining a network based on cryptographically binding password authentication key exchange (PAKE) information with a manufacturing installed certificate (MIC). Example method 500 illustrates aspects of the functions performed by authentication server 106 as described with reference to FIG. 1, FIG. 2, and FIG. 3. The logical operations described herein with respect to FIG. 5 may be implemented (1) as a sequence of computer-implemented acts or program modules running on a computing system and/or (2) as interconnected machine logic circuits or circuit modules within the computing system. In some examples, the method(s) 500 may be performed by a system comprising one or more processors and one or more non-transitory computer-readable media storing computer-executable instructions that, when executed by the one or more processors, cause the one or more processors to perform the method(s) 500.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 502 a client device receives a request for a manufacturing installed certificate (MIC) associated with the client device from an authentication server. For example, with reference to FIG. 1 the client device 108 receives a request from the authentication server 106 for a MIC 110. In another example, with reference to FIG. 2 at (3) the client device 202 receives a client device certificate request from the authentication server 204. This request is part of a TLs handshake between the authentication server 204 and the client device 202.

At operation 504 the client device transmits the MIC to the authentication server. The MIC includes a hash of password authentication key exchange (PAKE) information associated with the client device embedded in an extension of the MIC. For example, with reference to FIG. 1 the client device 108 transmits the MIC 110 to the authentication server 106. The MIC 110 is embedded with a hash of the client device PAKE information in an extension of the MIC 110. With reference to FIG. 2, at (6) the client device transmits its client certificate to the authentication server 204. Embedded in an extension of the client certificate is a hash of PAKE information associated with the client device 202. This exchange occurs during a TLS handshake between the client device 202 and the authentication server 204.

At operation 506 the client device receives an indication that the client device is allowed to onboard to the network from the authentication server. For example, with reference to FIG. 1 the authentication server 106 compares the client device PAKE information received in the extension of the MIC 110 as a hash at (2) to imported PAKE information received at (1), and if the authentication server 106 determines that the client device PAKE and the imported PAKE are the same, the client device 108 will receive an indication that the client device 108 is allowed to onboard to the network 102. With reference to FIG. 2, at (7) the authentication server 204 verifies the client certificate by (i) verifying that the certificate is signed by a trusted manufacturing root CA and (ii) the certificate contains a hash of PAKE information that matches the imported PAKE information. If the Imported PAKE information matches the PAKE information hashed in the extension of the client certificate, the client device 202 receives an indication that the client device is allowed to onboard to the network.

At operation 508 the client device joins the network based at leas in part on the indication received at operation 506. For example, with reference to FIG. 1 at (4), once the authentication server 106 has determined that the client device PAKE and the imported PAKE match, the client device 108 is allowed to onboard and join the network 102.

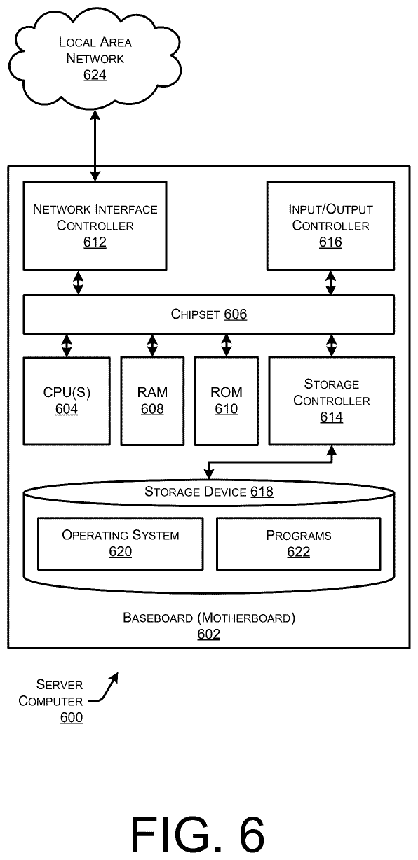

FIG. 6 shows an example computer architecture for a computing device (or network routing device) 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computing device 600 may, in some examples, correspond to a client device such as client device 108, client device 202, client device 302, or authentication server 106, and authentication server 204, described herein with respect to FIGS. 1, 2 and 3, respectively.

The computing device 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network, such as the network 624. Network 624 may, in some examples, correspond to network 102 of FIG. 1 or owner network 304 of FIG. 3. The chipset 606 can include functionality for providing network connectivity through a NIC 612, such as a gigabit Ethernet adapter. The NIC 612 is capable of connecting the computing device 600 to other computing devices over the network 624. It should be appreciated that multiple NICs 612 can be present in the computing device 600, connecting the computer to other types of networks and remote computer systems.

The computing device 600 can be connected to a storage device 618 that provides non-volatile storage for the computing device 600. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by client device 108, authentication server 106, client device 202, authentication server 204, or client device 302 and/or any components included therein, may be supported by one or more devices similar to computing device 600. Stated otherwise, some or all of the operations performed by client device 108, authentication server 106, client device 202, authentication server 204, or client device 302, or any components included therein, may be performed by one or more computing device 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to FIG. 6. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, by an authentication server of a network, an indication that a client device is attempting to join the network, the indication including first password authentication key exchange (PAKE) information;
receiving, by the authentication server of the network, a manufacturing installed certificate (MIC) from a client device, wherein the MIC includes a hash of second PAKE information, the second PAKE information associated with the client device and embedded in an extension of the MIC;
determining, by the authentication server of the network, whether the first PAKE information corresponds to the second PAKE information; and
based at least in part on the first PAKE information corresponding to the second PAKE information, allowing, by the authentication server of the network, the client device to join the network.

2. The method of claim 1, further comprising determining by the authentication server of the network that the MIC is signed by a trusted manufacturing root certificate authority (CA).

3. The method of claim 1, wherein the MIC is an X.509 initial device identity (IDevID) MIC.

4. The method of claim 1, wherein the network is a Wi-Fi network and further comprising:
receiving, by the authentication server of the Wi-Fi network, PAKE information for one or more client devices that are authorized to join the Wi-Fi network;
receiving, at an access point of the Wi-Fi network, a broadcast message from a client device, the broadcast message including a hash of the PAKE information associated with the client device;
determining, by the authentication server of the Wi-Fi network, whether the PAKE information associated with the client device corresponds to PAKE information of one or the one or more client devices authorized to join the Wi-Fi network;
in response to determining that the PAKE information associated with the client device corresponds to PAKE information of one or the one or more client devices authorized to join the Wi-Fi network; and
transmitting, by the access point of the Wi-Fi network and to the client device, instructions to initiate an 802.1X extensible authentication protocol (EAP) transaction in order to bootstrap.

5. The method of claim 4, wherein the broadcast message is an 802.11 Public Action frame.

6. The method of claim 1, wherein the authentication server is an 802.1X authentication, authorization, and accounting (AAA) server and the first PAKE information is imported via a GUI, API, or by scanning a QR code.

7. The method of claim 1, wherein PAKE information includes a client device PAKE identifier, PAKE password, PAKE protocol, and PAKE parameters required by the PAKE protocol.

8. A system comprising:
one or more processors; and
one or more computer-readable media storing computer-executable instructions that, when executed by the one or more processors, cause the one or more processors to perform operations comprising:
receiving, by an authentication server of a network, an indication that a client device is attempting to join the network, the indication including first password authentication key exchange (PAKE) information;
receiving, by the authentication server of the network, a manufacturing installed certificate (MIC) from a client device, wherein the MIC includes a hash of second PAKE information, the second PAKE information associated with the client device and embedded in an extension of the MIC;
determining, by the authentication server of the network, whether the first PAKE information corresponds to the second PAKE information; and
based at least in part on the first PAKE information corresponding to the second PAKE information, allowing, by the authentication server of the network, the client device to join the network.

9. The system of claim 8, the operations further comprising determining by the authentication server of the network that the MIC is signed by a trusted manufacturing root certificate authority (CA).

10. The system of claim 8, wherein the MIC is an X.509 initial device identity (IDevID) MIC.

11. The system of claim 8, wherein the network is a Wi-Fi network and further comprising:
receiving, by the authentication server of the Wi-Fi network, PAKE information for one or more client devices that are authorized to join the Wi-Fi network;
receiving, at an access point of the Wi-Fi network, a broadcast message from a client device, the broadcast message including a hash of the PAKE information associated with the client device;
determining, by the authentication server of the Wi-Fi network, whether the PAKE information associated with the client device corresponds to PAKE information of one or the one or more client devices authorized to join the Wi-Fi network;
in response to determining that the PAKE information associated with the client device corresponds to PAKE information of one or the one or more client devices authorized to join the Wi-Fi network; and
transmitting, by the access point of the Wi-Fi network and to the client device, instructions to initiate an 802.1X extensible authentication protocol (EAP) transaction in order to bootstrap.

12. The system of claim 11, wherein the broadcast message is an 802.11 Public Action frame.

13. The system of claim 8, wherein the authentication server is an 802.1X authentication, authorization, and accounting (AAA) server and the first PAKE information is imported via a GUI, API, or by scanning a QR code.

14. The system of claim 8, wherein PAKE information includes a client device PAKE identifier, PAKE password, PAKE protocol, and PAKE parameters required by the PAKE protocol.

15. One or more non-transitory computer-readable media storing instructions that, when executed, cause one or more processors to perform operations comprising:
receiving, by an authentication server of a network, an indication that a client device is attempting to join the network, the indication including first password authentication key exchange (PAKE) information;
receiving, by the authentication server of the network, a manufacturing installed certificate (MIC) from a client device, wherein the MIC includes a hash of second PAKE information, the second PAKE information associated with the client device and embedded in an extension of the MIC;
determining, by the authentication server of the network, whether the first PAKE information corresponds to the second PAKE information; and
based at least in part on the first PAKE information corresponding to the second PAKE information, allowing, by the authentication server of the network, the client device to join the network.

16. The one or more non-transitory computer-readable media of claim 15, the operations further comprising determining by the authentication server of the network that the MIC is signed by a trusted manufacturing root certificate authority (CA).

17. The one or more non-transitory computer-readable media of claim 15, wherein the network is a Wi-Fi network and further comprising:
receiving, by the authentication server of the Wi-Fi network, PAKE information for one or more client devices that are authorized to join the Wi-Fi network;
receiving, at an access point of the Wi-Fi network, a broadcast message from a client device, the broadcast message including a hash of the PAKE information associated with the client device;
determining, by the authentication server of the Wi-Fi network, whether the PAKE information associated with the client device corresponds to PAKE information of one or the one or more client devices authorized to join the Wi-Fi network;
in response to determining that the PAKE information associated with the client device corresponds to PAKE information of one or the one or more client devices authorized to join the Wi-Fi network; and
transmitting, by the access point of the Wi-Fi network and to the client device, instructions to initiate an 802.1X extensible authentication protocol (EAP) transaction in order to bootstrap.

18. The one or more non-transitory computer-readable media of claim 17, wherein the broadcast message is an 802.11 Public Action frame.

19. The one or more non-transitory computer-readable media of claim 15, wherein the authentication server is an 802.1X authentication, authorization, and accounting (AAA) server and the first PAKE information is imported via a GUI, API, or by scanning a QR code.

20. The one or more non-transitory computer-readable media of claim 15, wherein PAKE information includes a client device PAKE identifier, PAKE password, PAKE protocol, and PAKE parameters required by the PAKE protocol.
